(19) United States
(12) Patent Application Publication
(10) Pub. No.: US 2021/0248543 A1
(43) Pub. Date: Aug. 12, 2021

(54) SYSTEMS AND METHODS FOR USE IN DATA EXCHANGES RELATED TO SHIPPING LINES

(71) Applicant: MASTERCARD INTERNATIONAL INCORPORATED, Purchase, NY (US)

(72) Inventors: Paulo Fernandes, Davie, FL (US); John Paul Garden, Edinburgh (GB)

(21) Appl. No.: 17/168,636

(22) Filed: Feb. 5, 2021

Related U.S. Application Data
(60) Provisional application No. 62/971,363, filed on Feb. 7, 2020.

(51) Int. Cl. G06Q 10/08; G06Q 20/34; G06F 40/103; G06F 40/174

(52) U.S. Cl. CPC G06Q 10/083; G06Q 10/0875; G06F 40/174; G06F 40/103; G06Q 20/351

(57) ABSTRACT

Systems and methods for coordinating data exchanges are disclosed. One exemplary method generally includes receiving a work order for expected services by a terminal operator for handling cargo of a shipping line, converting the work order to a standard format, and requesting a pre-authorization for a transaction for the work order along with a virtual card number (VCN) for the shipping line. The method then includes receiving a final invoice for handling the cargo and extracting data from the final invoice for the expected services for handling the cargo and for unexpected services, and for a final invoice amount. The method further includes generating a standard form final invoice including the data for the expected services and the unexpected services, transmitting the standard form final invoice to the terminal operator and the shipping line, and initiating a transaction for the final invoice amount based on the VCN.

### CROSS-REFERENCE TO RELATED APPLICATION

This application claims the benefit of, and priority to, U.S. Provisional Application No. 62/971,363, filed on Feb. 7, 2020. The entire disclosure of the above-referenced application is incorporated herein by reference.

### FIELD

The present disclosure generally relates to systems and methods for use in coordinating shipping line data exchanges, and more specifically, to systems and methods for use in defining data exchanges between shipping lines and terminal operators in connection with terminal handling activities by the terminal operators.

### BACKGROUND

This section provides background information related to the present disclosure which is not necessarily prior art.

International and domestic freight shipping is a substantial component of export-oriented economies. It is estimated that around 90% of global trade flows through the maritime port ecosystems. A network of transportation entities, logistics companies, terminal operators, and government agencies facilitate the movement of cargo through ports. A port authority relies on a terminal operator, or multiple terminal operators, to interact with shipping lines to offload cargo from vessels, and also load cargo onto vessels. The port authority generates revenue through rent to the terminal operator(s), which, in turn, generate revenue through invoicing shipping lines for services rendered at the port. Often, the services associated with the loading and offloading of cargo are predictable, whereby certain charges will be known as a vessel approaches the port (e.g., number of containers on or off, etc.). However, various factors about the cargo, such as, for example, arrangement of containers on the vessel, types of containers on the vessel (e.g., refrigerated containers, etc.), damage to containers, repairs to damaged containers, weights of containers, etc., may give rise to unexpected and additional services by the terminal operator(s). After rendering the unexpected services, the terminal operator(s) adjusts billing for the shipping line and invoices the shipping line for the unexpected handling and additional services. Consistent with payment terms, the shipping line then provides payment for the invoiced services.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in coordinating data exchanges between shipping lines and terminal operators related to services provided by the terminal operators to the shipping lines;

FIG. 2 is a block diagram of an exemplary computing device that may be used in the system of FIG. 1;

FIG. 3 is an exemplary method, suitable for use with the system of FIG. 1, for coordinating data exchange between a shipping line and a terminal operator related to payment for services rendered by the terminal operator to the shipping line; and

FIG. 4 illustrates an exemplary itemized invoice for services rendered, which may be used in connection with the method of FIG. 3.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

When a terminal operator provides unexpected services (e.g., services not anticipated and/or not in a work order for a vessel entering a port, etc.), invoices are updated to include charges for the unexpected services together with charges for the expected services performed by the terminal operator. Invoicing processes associated with the services are often manual, and thus subject to error, and are often incomplete in that payments are not readily linked to specific invoices or services rendered for specific vessels of a shipping line. Uniquely, the systems and methods herein provide improved data exchanges between shipping lines, terminal operators, and one or more hubs, whereby invoicing processes are redefined according to a digital standard. The digital standard provides for a flow of data from the shipping lines, where virtual card numbers are then associated with work orders, and through which charges for services, expected and unexpected, are linked to the virtual card numbers. The virtual card numbers provide avenues for quick and generally automatic payment of invoices for the work orders when final, as well as linking between the work orders, particular vessels of the shipping lines, the invoices and the payments. In this manner, the data exchange (through the digital standard and virtual card numbers) provides insight into the services rendered by the terminal operators, and data structures which facilitate subsequent identification of the services to specific work orders or invoices, thereby permitting shipping lines to more effectively recoup charges from appropriate entities (e.g., cargo owners, etc.).

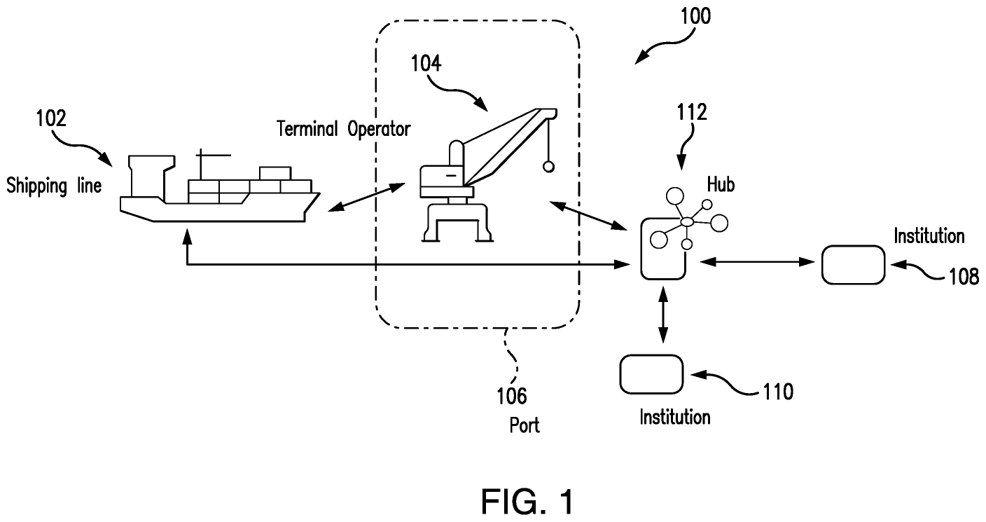

FIG. 1 illustrates an exemplary system 100 in which one or more aspects of the present disclosure may be implemented. Although parts of the system 100 are presented in one arrangement, it should be appreciated that other exemplary embodiments may include the same or different parts arranged otherwise, depending on, for example, privacy concerns and policies, data exchanged in the system, types of shipping lines and/or terminal operators involved in the system, etc.

As shown in FIG. 1, the illustrated system 100 generally includes a shipping line 102, a terminal operator 104 associated with a port 106, institutions 108 and 110, and a hub 112, each coupled to (and in communication with) one or more networks. The one or more networks is/are indicated by arrowed lines in FIG. 1, where the one or more networks may be part of the same network, or not. The one or more networks may each include, without limitation, a wired and/or wireless network, a local area network (LAN), a wide area network (WAN) (e.g., the Internet, etc.), a mobile network, and/or another suitable public and/or private network capable of supporting communication among two or more of the illustrated components of the system 100, or any combination thereof. The one or more networks may further be segregated or separated, whereby, for example, the one or more networks may include a private network provided by the hub 112 (e.g., as part of a payment network, etc.) to the institutions 108 and 110, and separately, a public network (e.g., the Internet, etc.) through which the shipping line 102 and/or the terminal operator 104 communicate with the hub 112. It should be appreciated that various ones of the illustrated components may also communicate with other ones of the components even if an arrowed line is not shown, via one or more networks (e.g., the shipping line 102 may communicate with the institution 108, the terminal operator 104 may communication with the institution 110, etc.).

The shipping line 102 in the system 100 generally includes one or more vessels, which are configured to move cargo (e.g., containers, bulk items, commodities, etc.) from one port to another port. The shipping line 102, in general, includes one or more vessels (e.g., one or more ships, boats, barges, etc.) that travel by ocean, river, canal, or other waterway from port to port. The cargo may be included, as indicated above, in containers, or in bulk/commodity. When the cargo includes containers, the containers are generally of a certain type or configuration (e.g., size, refrigerated or not, open or closed, insulated, tank configuration etc.) and are positioned, stacked and/or organized efficiently on a vessel to permit the shipping line 102 to maximize, or at least improve, the amount of cargo carried from one port to another (by the vessel). The containers may further be positioned, stacked and/or organized to provide efficient loading and offloading (to and from the vessel) at a next port location. While the shipping lines are generally related to ports, vessels and cargo, it should be appreciated that the present disclosure may be applicable to other shipping ecosystems in which an entity carries goods to a destination (e.g., via a suitable vehicle, plane, etc.), where another entity then provides services in connection with loading and/or offloading of the goods.

In this exemplary embodiment, the terminal operator 104 is located at the port 106. The terminal operator 104 may be the only terminal operator at the port 106, or may be one of several terminal operators at the port 106. The terminal operator 104 is configured to load and/or offload cargo to/from one or more vessels, or broadly, the shipping line 102, as the vessel(s) arrive at the port 106. The terminal operator 104 generally includes, without limitation, one or more cranes, forklifts, trucks, storage facilities, workers, etc. The terminal operator 104 often coordinates with government agencies (e.g., customs agencies, etc.) to abide by and/or confirm to applicable laws and regulations in the handling of the cargo from the vessel(s).

The institutions 108 and 110 of the illustrated system 100 generally include financial institutions, such as, for example, banks, etc., which issue accounts (e.g., checking accounts, savings accounts, credit accounts, etc.). Here, the institution 108 has issued a credit account to the shipping line 102, and the institution 110 has issued a bank account to the terminal operator 104. In addition, the hub 112 of the illustrated system 100 includes at least one computing device configured, generally, to coordinate data exchanges between the shipping line 102, the terminal operator 104, and the institutions 108 and 110, etc. The hub 112 may be a standalone entity, or the hub 112 may be integrated, in whole or in part, with another entity, such as, for example, a payment network (e.g., Mastercard™ network, etc.).

While only one shipping line 102, one terminal operator 104, one port 106, two institutions 108 and 110, and one hub 112 are illustrated in FIG. 1, it should be appreciated that a different number of shipping lines, terminal operators, ports, and institutions may be included in the system 100 in other system embodiments. For example, the hub 112 may be employed in connection with hundreds or thousands of different shipping lines (and associated financial institutions), and numerous different terminal operators (and associated financial institutions) at the same or different ports.

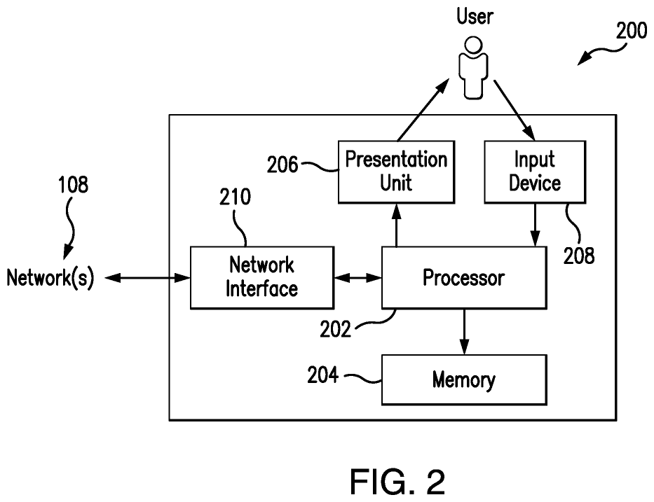

FIG. 2 illustrates an exemplary computing device 200 that can be used in the system 100. The computing device 200 may include, for example, one or more servers, workstations, computers, laptops, tablets, smartphones, other communication devices, etc. In addition, the computing device 200 may include one or multiple devices disposed in close proximity or distributed over a geographic region, so long as the computing devices are specifically configured to function as described herein. In particular, in the exemplary system 100 of FIG. 1, each of the shipping line 102, the terminal operator 104, and the institutions 108 and 110, may include, or may be implemented in, a computing device, such as the computing device 200. For example, the shipping line 102 may include computing devices disposed on land to communicate with one or more of its vessels, and/or may include computing devices located on the vessel(s) itself/themselves. In addition, the hub 112 includes a computing device consistent with the computing device 200. That said, the system 100 should not be considered to be limited to the computing device 200, as described below, as different computing devices and/or arrangements of computing devices may be used. In addition, different components and/or arrangements of components may be used in other computing devices.

With reference now to FIG. 2, the computing device 200 generally includes a processor 202, and a memory 204 that is coupled to (and in communication with) the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic device (PLD), a gate array, and/or any other circuit or processor capable of the functions described herein. The above examples are exemplary only, and are not intended to limit in any way the definition and/or meaning of processor.

The memory 204, as described herein, is one or more devices that enable information, such as executable instructions and/or other data, to be stored and retrieved. The memory 204 may be configured to store, without limitation, work orders, invoices, authorizations, transaction data, virtual card numbers, shipping schedules, manifests, shipping content data, travel routes, and/or other types of data suitable for use as described herein, etc. In addition, the memory 204 may include one or more computer-readable storage media, such as, without limitation, dynamic random access memory (DRAM), static random access memory (SRAM), read only memory (ROM), erasable programmable read only memory (EPROM), solid state devices (e.g., EMV chips, etc.), CD-ROMs, thumb drives, tapes, flash drives, hard disks, and/or any other type of volatile or nonvolatile physical or tangible computer-readable media. It should be appreciated that the memory 204 may include a variety of different memories. In various embodiments, computer-executable instructions may be stored in the memory 204 for execution by the processor 202 to cause the processor 202 to perform one or more of the operations described herein (e.g., one or more of the operations recited in method 300, etc.), such that the memory 204 is a physical, tangible, and non-transitory computer-readable media and such that the instructions stored in the memory 204 enable the computing device to operate as (or transform the computing device into) a specific-purpose device configured to then effect the features described herein.

The computing device 200 also includes a presentation unit 206 and an input device 208 coupled to (and in communication with) the processor 202. However, it is contemplated that the presentation unit 206 and the input device 208 may be omitted from certain computing device embodiments.

The presentation unit 206 outputs information and/or data to a user of the given computing device 200 by, for example, displaying, audibilizing, and/or otherwise outputting the information and/or data. In some embodiments, the presentation unit 206 may comprise a display device such that various interfaces (e.g., application screens, webpages, etc.) may be displayed at computing device 200, and in particular at the display device, to display such information and/or data, etc. With that said, the presentation unit 206 may include, without limitation, a cathode ray tube (CRT), a liquid crystal display (LCD), a light-emitting diode (LED) display, an organic LED (OLED) display, an “electronic ink” display, speakers, combinations thereof, etc. In addition, the presentation unit 206 may include multiple devices in some embodiments.

The input device 208, when present in the computing device 200, is configured to receive input from the user of the computing device 200. The input device may include, without limitation, a keyboard, a mouse, a touch sensitive panel (e.g., a touch pad or a touch screen, etc.), another computing device, and/or an audio input device. Further, in some exemplary embodiments, a touch screen, such as that included in a tablet, a smartphone, or similar device, may function as both the presentation unit 206 and the input device 208.

The illustrated computing device 200 further includes a network interface 210 coupled to (and in communication with) the processor 202 and the memory 204. The network interface 210 may include, without limitation, a wired network adapter, a wireless network adapter, a mobile adapter, or other device capable of communicating to one or more different networks (e.g., the Internet, a private or public LAN, WAN, mobile network, combinations thereof, or other suitable network, etc.), or separate therefrom. In some exemplary embodiments, the processor 202 and one or more network interfaces may be incorporated together.

Referring again to FIG. 1, when a vessel of the shipping line 102 is inbound to the port 106 (e.g., one, two, three or more days prior to arrival or other interval, etc.), the shipping line 102 is configured to generate and transmit a work order to the terminal operator 104 (in preparation for the terminal operator 104 to load/offload the vessel once the vessel arrives at the port 106) and also to the hub 112 (as part of an enrollment by the shipping line 102 for the data exchange services described herein, etc.). The work order generally includes, without limitation, an identifier associated with the vessel, an identifier of the shipping line 102, a listing of the cargo to be loaded/offloaded to/from the vessel at the port 106 and/or services to be provided at the port 106, and potentially, an amount (e.g., a charge for each of the listed services, etc.) and an identification of the institution 108 (as associated with the shipping line 102). The work order may be transmitted, for example, through email or through other suitable applications at the computing device 200 of the shipping line 102.

In response, the hub 112 is configured to receive the work order from the shipping line 102 and to convert the work order into a particular format (e.g., a standard electronic format, a customer designated format, an electronic format that matches an enterprise resource planning (ERP) platform, etc.).

Next, the hub 112 is configured to identify the institution 108 associated with the shipping line 102 (e.g., associated with the credit account issued to the shipping line 102, etc.), from the work order, and to request a virtual card number (VCN) from the institution 108 for a payment transaction (against the shipping line's credit account) based on the work order (e.g., as a temporary authorization against the shipping line's available credit, etc.). The request includes the identifier of the shipping line 102 and a requested amount of credit associated with the work order (for temporary authorization). The requested amount may be based on the listing of services in the work order, or an amount included in the work order, as well as a margin. For example, where the work order indicates $100,000 in charges, the requested amount may be $120,000 (i.e., a 20% or $20,000 margin). The request may include additional information, as needed, for the institution 108, for example, to issue the VCN and associate the requested credit to the shipping line 102 (and, when present, to the credit account issued to the shipping line 102 by the institution 108). It should be appreciated that the request may be provided by the shipping line 102 to the hub 112 via payment rails of the hub 112, for instance, when the hub 112 is integrated into a payment network (e.g., via rails used by the hub 112 and/or the payment network to process conventional payment account transactions, etc.). For example, the request may be transmitted by the shipping line 102 as an authorization request message to the hub 112, consistent with the ISO 8583 standard, or other suitable standard, with the appropriate information for the request then included in data elements of the authorization request message to indicate the data described above.

While the above description is provided in terms of the institution 108 having issued a credit account to the shipping line 102 (or the shipping line 102 having a pre-existing credit line with the institution 108), it should be appreciated that the shipping line 102 may not have a preexisting account with the institution 108 in all embodiments. For example, in one or more embodiments, the institution 108 may be configured to issue temporary credit to the shipping line 102, for example, based on prior interactions with the shipping line 102, etc., to account for the charges in the work order, etc.

In response to the request by the hub 112 for the VCN, the institution 108 is configured to determine whether or not to pre-authorize the request for credit. In the illustrated embodiment, this includes the institution 108 determining whether the requested amount for pre-authorization is within the available credit associated with the shipping line's credit account (whereby a portion of the shipping line's available credit would then be temporarily held based on the requested amount for pre-authorization). When the shipping line 102 has sufficient credit, the credit is pre-authorized by the institution 108 and the institution 108 is configured to then transmit a response to the hub 112, which includes the VCN for the credit account or line (and, potentially, a confirmation of the hold and the amount associated with the pre-authorization).

In turn, when the approval for the credit account or line is received, along with the VCN, the hub 112 is configured to notify the shipping line 102 and the terminal operator 104 of the pre-authorization (and, in some embodiments, of the VCN as well) and the estimated charges for the loading and/or offloading at the port 106 (which is based, at least in part, on the work order provided above and the added margin (if any)). The hub 112 is further configured to store the work order, the pre-authorization, and the VCN in a data structure, in which the VCN/pre-authorization is linked to the work order (e.g., by vessel name/number, date, or work order number included therein, etc.). Additionally, the hub 112 is configured to transmit a notification of the pre-authorization to the institution 110 associated with the terminal operator 104, which indicates that funds for the services to be rendered at the port 106 are accessible at the shipping line's institution 108 and are being held for final settlement. This notification may also be provided via the payment rails of the hub 112, when the hub 112 is integrated into the payment network, as generally described above (with regard to the request for the VCN), whereby the notification may include, for example, an authorization response message or advisement message consistent with the ISO 8583 standard (or other suitable standard). In connection therewith, the authorization response message or advisement message may then include the appropriate information for the pre-authorization, VCN, and work order within data elements of the authorization response message or advisement message.

Thereafter, the vessel of the shipping line 102 arrives at the port 106, and the terminal operator 104 is configured to load and/or offload cargo from the vessel consistent with the work order. However, the load and/or offload process may involve unexpected services, such as, for example, special equipment hires (heavy lifts), pilotage charges, tug charges, mooring charges, port dues, wharfing chargers, other terminal handling activities and/or charges, etc. When the loading and/or offloading is completed (or at another time), the terminal operator 104 is configured to generate a final invoice for the vessel. The final invoice includes line item detail for charges for the expected services included in the work order and the charges for the unexpected or added services, along with a final invoice amount and remittance information (e.g., an indication of the institution 110 associated with the terminal operator 104, etc.). In addition, the final invoice may also include a vessel name/number, applicable date, and/or work order number (corresponding to the original work order, etc.), etc. The terminal operator 104 is configured to submit the final invoice to the shipping line 102 (e.g., via email, etc.) and to the hub 112 (e.g., as a message via the payment rails of the hub 112 consistent with the ISO 8583 standard, etc.).

Upon receipt, the hub 112 is configured to extract the remittance information and line item detail of the invoice. The hub 112 is configured to store the line item detail in designated computing devices of each of the shipping line 102 and the terminal operator 104 (e.g., enterprise resource planning (ERP) systems of the shipping line 102 and terminal operator 104, etc.). In this manner, the line item detail is stored in conjunction with the specific work order, the final invoice, and other details of the specific loading and/or offloading cycle of the vessel at the port 106 on the time/date at which the particular service(s) was/where performed. It should be appreciated that in some embodiments, rather than accessing the ERP system, for example, the hub 112 may be configured to transmit the final invoice, including the line item details, to a computing device associated with the ERP system, to the shipping line 102 and/or to the terminal operator 104 in a format compatible with the ERP system (e.g., EDI, XML, PDF, TEXT, Binary, etc.) (e.g., consistent with e-invoicing standards/formats, etc.), whereupon the ERP system stores the line item detail for the loading and/or offloading cycle of the vessel at the port 106 on the corresponding time/date. Additionally, if not included in the final invoice, the hub 112 is configured to retrieve the VCN for the shipping line 102 from the database, based on the work order number, etc. And, the hub 112 is configured to then submit the transaction to the institutions 108 and 110 (e.g., along payment rails of the hub 112 via ISO 8583 standard messages, etc.), based on the VCN. And, the institution 108 is configured to record the transaction against the VCN and the associated credit account for the shipping line 102.

Later, the payment network (as associated with the hub 112, for example) is configured to clear and settle the transaction, whereby funds are moved to the account of the terminal operator 104 issued by the institution 110. The institution 108 is configured to then bill the amount to the shipping line 102, which is to be paid by the shipping line 102 consistent with the applicable terms of the credit account or line issued by the institution 108 (e.g., 30-60 days, etc.).

When the funds are received, the hub 112 is configured to notify the shipping line 102 and the terminal operator 104, either separately (e.g., via email, or ISO 8583 standard message, etc.) or by storing and/or notifying of the payment in/to the designated computing devices of the shipping line 102 and the terminal operator 104. In this manner, the payment is tied to the specific final invoice thereby permitting reconciliation of the line items. The shipping line 102 may then pursue reimbursement for charges from expected and unexpected services from cargo owners, based on the line item detail included in the designated computing devices of the shipping line 102 (e.g., the ERP systems, etc.) and tied to the specific work order, invoice, and loading and/or offloading cycle of the vessel at the port 106 on that time/date.

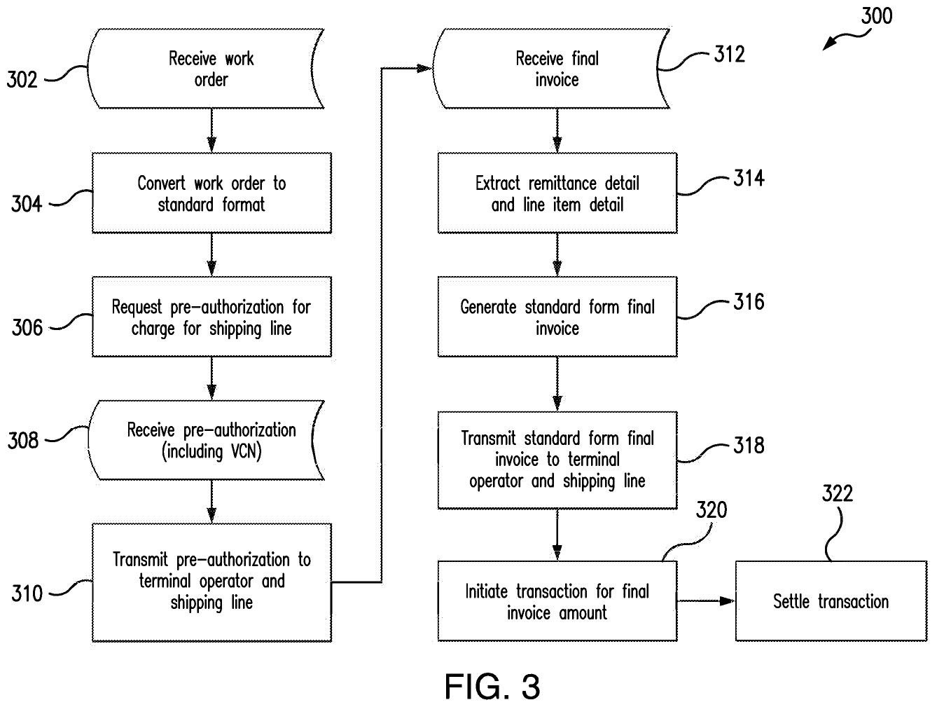

FIG. 3 illustrates an exemplary method 300 of coordinating data exchange between a shipping line and a terminal operator related to payment for services rendered by the terminal operator. The method 300 is described below in connection with the exemplary system 100 and the exemplary computing device 200 previously described. However, it should be appreciated that the method 300 is not limited to the system 100, or the computing device 200, but may be implemented in a variety of different systems and/or computing devices. Likewise, the systems and computing devices described herein should not be understood to be limited to the exemplary method 300, or other methods described herein.

At the outset in the method 300, when a vessel of the shipping line 102 approaches the port 106, the shipping line 102 generates and transmits to the hub 112 (via one or more network communications with the hub 112) a work order for the cargo onboard the vessel, or to be loaded/offloaded to/from the vessel (e.g., based on registration of the shipping line 102 with the hub 112 for the services described herein (e.g., to facilitate improved payment for services rendered, etc.), etc.). The work order, as above, includes, for example, a name and type of the vessel, a name of the shipping line 102, an indication of the institution 108 through which the shipping line 102 has credit, an expected arrival date/time of the vessel at the port 106, a listing of the cargo to be loaded/offloaded to/from the vessel, and/or services to be provided at the port 106, etc. In response, the hub 112 receives, at 302, the work order from the shipping line 102. And, at 304, the hub 112 converts the work order received from the shipping line 102 into a standard format, for example, for use in communicating details thereof with the institutions 108, 110 and with the terminal operator 104 (e.g., for use with messaging capable of being transmitted via payment rails of a payment network with which the hub 112 is associated, etc.).

Based on the information included in the work order, the hub 112 next requests, at 306, from the institution 108 (e.g., transmits a request message to the institution 108 for (via one or more network communications with the institution 108), etc.), pre-authorization to fund the services to be performed by the terminal operator 104 for the work order and/or vessel (broadly, a request for a VCN from the institution 108 for identifying the shipping line's account to be used to fund the work order). In connection therewith, the information received by the institution 108 from the hub 112 (e.g., as part of the request for pre-authorization, etc.) may include, for example, the identity of the shipping line 102 (e.g., name, contact information, government ID number(s), etc.), an indication of the vessel and an amount of credit requested, detail of the work order (or the work order itself), etc. That said, the information may include more or less information as is required, or desired, by the institution 108. The pre-authorization, then, is directed to the account issued by the institution 108 to the shipping line 102, and is based on whether or not the shipping line's account has sufficient credit available to satisfy the amount included in the request (as a temporary authorization on the available credit associated with the shipping line's account). Alternatively, in embodiments where the shipping line 102 does not have a credit account with the institution 108, the pre-authorization request may be directed to a new account (or to a temporary account) issued to the shipping line 102 by the institution 108 and include the required credit (e.g., based on prior interactions between the shipping line 102 and the institution 108, etc.).

It should be appreciated that the required credit at the shipping line's account with the institution 108 will be at least enough to cover the cost of the services included in the work order, and potentially, a margin to account for costs for unexpected services associated with the loading and/or offloading of cargo to/from the vessel. It should also be appreciated that the request for pre-authorization may be provided via the payment rails of the hub 112, for example, when the hub 112 is integrated into a payment network. For instance, in such embodiments, the hub may submit a pre-authorization request message, via the ISO 8583 standard, or other suitable standard, to the institution 108 with the appropriate information for the request (as discussed above) included in data elements thereof.

When the institution 108 authorizes the amount (e.g., in connection with an existing account, or a new account, etc.), the institution 108 generates a VCN specific to a transaction for the work order (and specific to the shipping line's account) and provides the pre-authorization (including the VCN) to the hub 112 (via one or more network communications with the hub 112, via the payment rails of the hub 112, etc.). In turn, the hub 112 receives the pre-authorization from the institution 108 (and the VCN), at 308. In addition, the institution 108 places a temporary hold on the required credit associated with the expected transaction, against the shipping line's account.

Next in the method 300, the hub 112 transmits, at 310, the pre-authorization to the shipping line 102 and to the terminal operator 104 (via one or more network communications with the shipping line 102 and the terminal operator 104) along with the estimated charges for the loading and/or offloading at the port 106 (which is based, at least in part, on the work order provided above) and any added margin. And, the hub 112 also transmits a notification of the pre-authorization to the institution 110, indicating that funds for the services to be rendered at the port 106 are accessible at the institution 108 and are being held for final settlement (along with an indication of the amount of funds being held). Like above, the pre-authorization and the notification may be provided to the shipping line 102 and terminal operator 104 and to the institution 110, respectively, via the payment rails of the hub 112, when the hub 112 is integrated into a payment network. For example, the notification may include an advisement or other reply message to the pre-authorization request message, consistent with the ISO 8583 standard, or other suitable standard, with the appropriate information (as discussed herein) included in data elements thereof.

Thereafter, the vessel of the shipping line 102 arrives at the port 106, and the terminal operator 104 proceeds to load and/or offload cargo from the vessel in accordance with the work order. In some instances, the loading and/or offloading may involve unexpected services, and when the loading and/or offloading is completed (or at another time), the terminal operator 104 generates and transmits a final invoice for the vessel to the hub 112 (e.g., based on registration of the terminal operator 104 with the hub 112 for the services described herein (e.g., to facilitate improved payment for services rendered thereby, etc.), etc.) and to the shipping line 102. As described above, the final invoice includes line item detail for charges for the expected services included in the work order and charges for the unexpected services, along with a final invoice amount and remittance information (e.g., information for the institution 110 associated with the terminal operator 104 and/or the terminal operator's account at the institution 110, etc.). The final invoice also includes a vessel name/number, applicable date of services provided by the terminal operator 104, and/or the work order number for the original work order provided by the shipping line 102, etc. Once completed, then, the terminal operator 104 is configured to submit the final invoice to the shipping line 102 (e.g., via email, etc.) and to the hub 112 (e.g., via an ISO 8583 standard message along the payment rails associated with the hub 112, etc.).

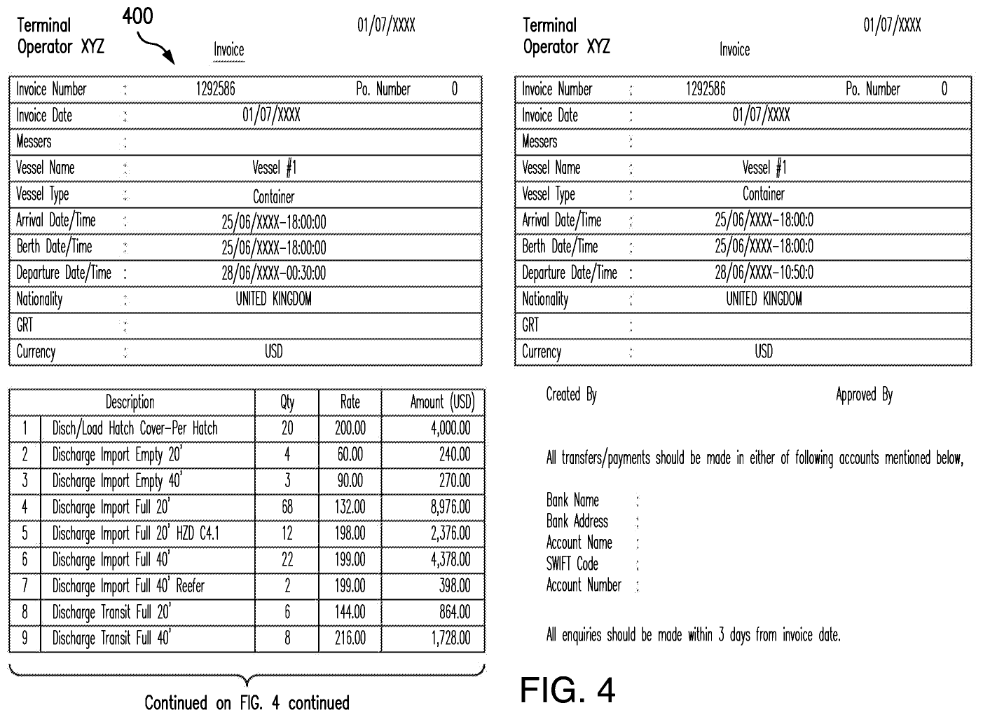

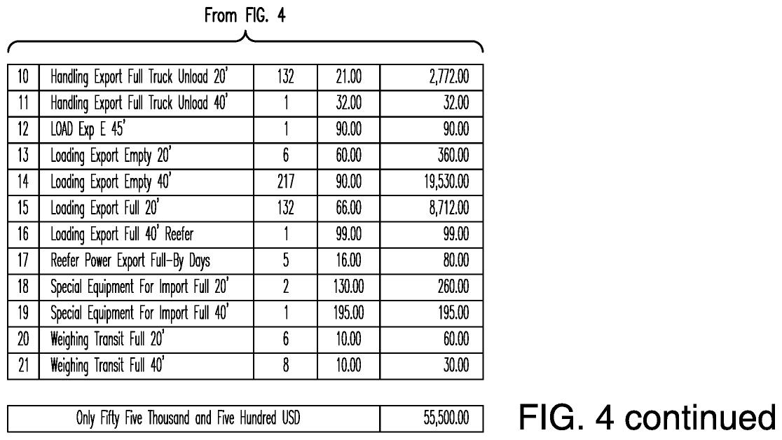

The hub 112, in turn, receives the final invoice, at 312. FIG. 4 illustrates a sample final invoice 400 (comprising two pages), which includes the line item detail for a vessel named Vessel #1. And, at 314, the hub 112 extracts the remittance details and the line item details from the final invoice (e.g., from the invoice 400, etc.). Then, the hub 112 generates, at 316, a standard form final invoice based on the extracted details (e.g., the hub 112 extracts the data from the invoice received from the terminal operator 104 and generates a new invoice according to a predefined customer form, a predefined ERP form, etc.). The standard form invoice is transmitted, by the hub 112, back to the terminal operator 104 and also to the shipping line 102, at 318. The line item detail, and more generally, the overall standard form final invoice, may be transmitted in a format compatible with the ERP system (e.g., EDI, XML, PDF, TEXT, Binary, etc.) (e.g., consistent with e-invoicing standards/formats, etc.), whereupon the ERP system (as associated with the shipping line 102 and the terminal operator 104) stores the line item detail for the loading and/or offloading cycle of the vessel at the port 106 on that time/date (e.g., within the designated computing devices of the shipping line 102 and the terminal operator 104, etc.).

Finally, at 320, the hub 112 initiates a transaction for the final invoice amount, from the pre-authorization, with the VCN (e.g., via an ISO 8583 standard message, etc.). This may include, for example, transmitting an authorization request message (e.g., consistent with the ISO 8583 standard, etc.) (including the VCN) to the institution 108. The institution 108 records the transaction against the VCN and associated held credit for the transaction. Later, the hub 112, as part of a payment network in this embodiment, settles, at 322, the transaction, whereby funds are moved to the account of the terminal operator 104 issued by the institution 110.

When the funds are received, the hub 112 further notifies the shipping line 102 and the terminal operator 104, either separately (e.g., via email, or ISO 8583 standard message, etc.) or by storing and/or notifying of the payment in/to the designated computing devices of the shipping line 102 and the terminal operator 104. In this manner, the payment is tied to the specific final invoice thereby permitting reconciliation of the line items. The shipping line 102 may then pursue reimbursement for charges from expected and unexpected services from cargo owners, based on the line item detail included in the designated computing device of the shipping line 102 (e.g., ERP systems, etc.) and tied to the specific work order, invoice, and loading and/or offloading cycle of the vessel at the port 106 on that time/date.

In view of the above, the systems and methods herein generally enable data exchanges in connection with services provided by a terminal operator to a shipping line for a vessel at a port. Additionally, the systems and methods herein provides technical solutions suitable to be deployed alongside the ERP environment of the shipping line and the terminal operator to enable full integration to their workflow and to fulfil end-to-end automation and reconciliation.

As will be appreciated based on the foregoing specification, the above-described embodiments of the disclosure may be implemented using computer programming or engineering techniques including computer software, firmware, hardware or any combination or subset thereof, wherein the technical effect may be achieved by one or more of: (a) receiving, at a hub computing device, a work order representative of expected services for handling cargo associated with a shipping line by a terminal operator; (b) converting, by the hub computing device, the work order to a standard format; (c) requesting, by the hub computing device, from an institution associated with the shipping line, a pre-authorization for a transaction based on the standard format of the work order; (d) in response to receipt of the pre-authorization from the institution, transmitting, by the hub computing device, the pre-authorization to an institution associated with the terminal operator, the pre-authorization including a virtual card number (VCN) for the shipping line; (e) receiving, by the hub computing device, a final invoice for handling the cargo by the terminal operator; (f) extracting, by the hub computing device, data from the final invoice, the extracted data including line item detail for the expected services for handling the cargo, line item detail for at least one unexpected service relating to handling the cargo, and a final invoice amount; (g) generating, by the hub computing device, a standard form final invoice, the standard form final invoice including the line item detail for the expected services and the at least one unexpected service; (h) transmitting, by the hub computing device, the standard form final invoice to the terminal operator and the shipping line; (i) initiating, by the hub computing device, a transaction for the final invoice amount based on the VCN; (j) settling, by the hub computing device, the transaction between the institution associated with the shipping line and the institution associated with the terminal operator; (k) in response to receipt of the pre-authorization from the institution, storing, by the hub computing device, the VCN in a data structure in association with the work order and the pre-authorization; (l) in response to receipt of the pre-authorization from the institution, transmitting, by the hub computing device, the pre-authorization to the terminal operator and the shipping line; and/or (m) storing, by the hub computing device, the line item detail for the expected services for handling the cargo and the line item detail for at least one unexpected service relating to handling the cargo in an enterprise resource planning (ERP) system associated with the shipping line and/or the terminal operator.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for coordinating data exchanges, the computer-implemented method comprising:
receiving, at a hub computing device, a work order representative of expected services for handling cargo associated with a shipping line by a terminal operator;
converting, by the hub computing device, the work order to a standard format;
requesting, by the hub computing device, from an institution associated with the shipping line, a pre-authorization for a transaction based on the standard format of the work order;
in response to receipt of the pre-authorization from the institution, transmitting, by the hub computing device, the pre-authorization to an institution associated with the terminal operator, the pre-authorization including a virtual card number (VCN) for the shipping line;
receiving, by the hub computing device, a final invoice for handling the cargo by the terminal operator;
extracting, by the hub computing device, data from the final invoice, the extracted data including line item detail for the expected services for handling the cargo, line item detail for at least one unexpected service relating to handling the cargo, and a final invoice amount;
generating, by the hub computing device, a standard form final invoice, the standard form final invoice including the line item detail for the expected services and the at least one unexpected service;
transmitting, by the hub computing device, the standard form final invoice to the terminal operator and the shipping line; and
initiating, by the hub computing device, a transaction for the final invoice amount based on the VCN.

2. The computer-implemented method of claim 1, wherein requesting the pre-authorization includes transmitting a pre-authorization request message to the institution associated with the shipping line, wherein the preauthorization request message is consistent with the ISO 8583 standard.

3. The computer-implemented method of claim 1, wherein the hub computing device is a payment network computing device.

4. The computer-implemented method of claim 3, further comprising settling, by the hub computing device, the transaction between the institution associated with the shipping line and the institution associated with the terminal operator.

5. The computer-implemented method of claim 1, wherein initiating the transaction includes transmitting an authorization request message for the transaction to at least the intuition associated with the shipping line, wherein the authorization request message is consistent with the ISO 8583 standard.

6. The computer-implemented method of claim 1, wherein the expected services for handling the cargo include expected services for offloading and/or loading the cargo from/to a vessel of the shipping line, at a port.

7. The computer-implemented method of claim 1, further comprising, in response to receipt of the pre-authorization from the institution, storing, by the hub computing device, the VCN in a data structure in association with the work order and the pre-authorization.

8. The computer-implemented method of claim 1, further comprising, in response to receipt of the pre-authorization from the institution, transmitting, by the hub computing device, the pre-authorization to the terminal operator and the shipping line.

9. The computer-implemented method of claim 1, further comprising storing, by the hub computing device, the line item detail for the expected services for handling the cargo and the line item detail for at least one unexpected service relating to handling the cargo in an enterprise resource planning (ERP) system associated with the shipping line and/or the terminal operator.

10. A system for coordinating data exchanges between a shipping line and a terminal operator, the system comprising a hub computing device configured to:
receive a work order representative of expected services for handling cargo associated with a shipping line by a terminal operator;
convert the work order to a standard format;
request, from an institution associated with the shipping line, a pre-authorization for a transaction based on the standard format of the work order;
in response to receipt of the pre-authorization from the institution, transmit the pre-authorization to an institution associated with the terminal operator, the pre-authorization including a virtual card number (VCN) for the shipping line;
receive a final invoice for handling the cargo by the terminal operator;
extract data from the final invoice, the extracted data including line item detail for the expected services for handling the cargo, line item detail for at least one unexpected service relating to handling the cargo, and a final invoice amount;
generate a standard form final invoice, the standard form final invoice including the line item detail for the expected services and the at least one unexpected service;
transmit the standard form final invoice to the terminal operator and the shipping line; and
initiate a transaction for the final invoice amount based on the VCN.

11. The system of claim 10, wherein the hub computing device is configured, in connection with requesting the pre-authorization, to transmit a pre-authorization request message to the institution associated with the shipping line, wherein the preauthorization request message is consistent with the ISO 8583 standard.

12. The system of claim 10, wherein the hub computing device is configured, in connection with initiating the transaction, to transmit an authorization request message for the transaction to at least the intuition associated with the shipping line, wherein the authorization request message is consistent with the ISO 8583 standard.

13. The system of claim 10, wherein the expected services for handling the cargo include expected services for offloading and/or loading the cargo from/to a vessel of the shipping line, at a port.

14. The system of claim 10, wherein the hub computing device is further configured, in response to receipt of the pre-authorization from the institution, to store the VCN in a data structure in association with the work order and the pre-authorization.

15. The system of claim 10, wherein the hub computing device is further configured, in response to receipt of the pre-authorization from the institution, to transmit the pre-authorization to the terminal operator and the shipping line.

16. The system of claim 10, further comprising a payment network in communication with the institution associated with the shipping line and the institution associated with the terminal operator, wherein the payment network includes the hub computing device.

17. The system of claim 16, wherein the hub computing device is further configured to settle the transaction between the institution associated with the shipping line and the institution associated with the terminal operator.

18. The system of claim 10, wherein the hub computing device is further configured to store the line item detail for the expected services for handling the cargo and the line item detail for at least one unexpected service relating to handling the cargo in an enterprise resource planning (ERP) system associated with the shipping line and/or the terminal operator.

19. A non-transitory computer readable storage medium including executable instructions for coordinating data exchanges, which when executed by at least one processor, cause the at least one processor to:
receive a work order representative of expected services for handling cargo associated with a shipping line by a terminal operator;
convert the work order to a standard format;
request, from an institution associated with the shipping line, a pre-authorization for a transaction based on the standard format of the work order;
in response to receipt of the pre-authorization from the institution, transmit the pre-authorization to an institution associated with the terminal operator, the pre-authorization including a virtual card number (VCN) for the shipping line;
receive a final invoice for handling the cargo by the terminal operator;
extract data from the final invoice, the extracted data including line item detail for the expected services for handling the cargo, line item detail for at least one unexpected service relating to handling the cargo, and a final invoice amount;
generate a standard form final invoice, the standard form final invoice including the line item detail for the expected services and the at least one unexpected service;
transmit the standard form final invoice to the terminal operator and the shipping line; and
initiate a transaction for the final invoice amount based on the VCN.

20. The non-transitory computer readable storage medium of claim 19, wherein the processor is included in a payment network.
